(19) United States
(12) Patent Application Publication
(10) Pub. No.: US 2011/0078289 A1
(43) Pub. Date: Mar. 31, 2011

(54) NETWORK CONFIGURATION METHOD FOR NETWORKING DEVICE AND ASSOCIATED NETWORK CONFIGURATION MODULE

(75) Inventors: Jen-Chieh Lo, Sanchong City (TW); Shih-Chuan Fu, Hsinchu City (TW)

(73) Assignee: REALTEK SEMICONDUCTOR CORP., Hsinchu (TW)

(21) Appl. No.: 12/887,493

(22) Filed: Sep. 21, 2010

Related U.S. Application Data
(60) Provisional application No. 61/245,669, filed on Sep. 25, 2009.

(51) Int. Cl. G06F 15/177

(52) U.S. Cl. 709/220

(57) ABSTRACT

A network configuration method for a networking device and an associated network configuration module are provided to simplify the network configuration process of the networking device, thereby increasing user's convenience. The method connects a storage device to another networking device, so as to obtain network configuration information thereof and store it into the storage device. Next, the method connects the storage device to the networking device, and configures the networking device according to the network configuration information stored in the storage device.

### CROSS REFERENCE TO RELATED APPLICATIONS

This application claims the benefit of U.S. Provisional Application No. 61/245,669, filed on Sep. 25, 2009 and entitled “Automatic Network Configuration and Detection”, the contents of which are incorporated herein.

### BACKGROUND

(a). Technical Field

The disclosure relates to network configuration of a networking device.

(b). Description of the Related Arts

In recent years, more networking devices are presented to the public. In addition to already-popularized personal computers (PCs) and notebooks, other devices such as mobile phones, tablet PCs, etc. are also available for Internet users. Even some consumer electronics such as televisions (TVs), digital cameras, etc., not networking-enabled originally, have been added the networking function to meet user's needs. However, many end-users often encounter difficulties in configuring the network setting of these consumer electronics. Take the TV as example, since the TV does not have a keyboard as in the PC, it is inconvenient to input data during the network configuration process; moreover, not all users are familiar with the network configuration process. Though a user applies for networking services from an Internet service provider (ISP), the ISP only assures the correct network configuration of the user's computer, not inclusive of whether the TV is able to connect to the Internet. Thus, connection between the TV and the Internet is a problem.

### SUMMARY

The exemplary embodiments comprise a network configuration method of a networking device and an associated network configuration module which can simplify the network configuration process of the networking device, thereby increasing the user's convenience.

In an exemplary embodiment, a network configuration method for a networking device is disclosed. The network configuration method comprises: connecting a storage device to another networking device; obtaining a network configuration information of the another networking device and storing the network configuration information into the storage device; connecting the storage device to the networking device; and configuring the networking device according to the network configuration information stored in the storage device.

In another exemplary embodiment, a network configuration module is provided. The network configuration module comprises: a first networking device; a second networking device having a network configuration information; and a storage device for obtaining and storing the network configuration information from the second networking device; wherein the storage device provides the first networking device the network configuration information for configuring the first networking device.

### BRIEF DESCRIPTION OF THE DRAWINGS

FIG. 1 is a flowchart of an exemplary embodiment of the network configuration method of the networking device.

FIGS. 2A-2D are diagrams of four common network types.

FIG. 3 is a block diagram of an exemplary embodiment of the network configuration module.

### DETAILED DESCRIPTION

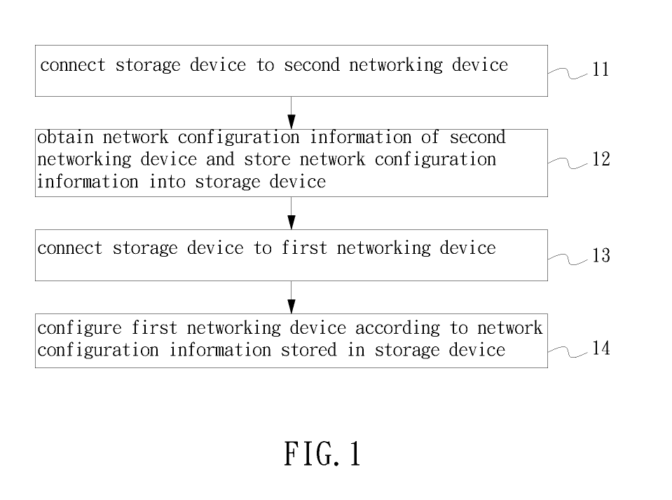

Methods and apparatuses involving the use of a networking device and an associated network configuration module which can assist the network configuration process of the networking device by acquiring and using the network configuration of another networking device are provided, thereby simplifying the whole configuration process. FIG. 1 is a flowchart of an embodiment of the network configuration method of the networking device. The networking device (denoted as the first networking device) can be a TV. In step 11, a storage device is connected to another networking device (denoted as the second networking device). The second networking device can be a computer, e.g. a PC or notebook. The storage device can be a USB flash drive, or any other storage device. It is noted that the I/O interface of the storage device is supported by both the first and second networking devices so as to facilitate data transmission.

In step 12, a network configuration information of the second networking device is obtained and stored into the storage device. The network configuration information includes the TCP/IP settings required for Internet connections, e.g. IP address, sub-net mask, gateway address, domain name server (DNS) address, etc. Step 12 can obtain the network configuration information by executing a software program by the second networking device. For instance, if the first and second networking devices are the TV and PC respectively, then when the user buys a TV, the TV manufacturer can provide the user an additional USB flash drive which stores a related application software containing a program for acquiring the network configuration information. When the user installs the related application software on the computer, the program is executed simultaneously to retrieve the network configuration information of the computer. It is noted that before storing the network configuration information of the second networking device into the storage device, step 12 can further comprise: determining whether the network configuration information is valid, i.e. determining whether the second networking device can successfully connect to the Internet.

In step 13, the storage device is connected to the first networking device. In step 14, the first networking device is configured according to the network configuration information stored in the storage device. In this embodiment, step 14 is executed when a network interface of the first networking device is connected to a network. The network interface can be a wired or wireless interface, and the network can be a local area network (LAN). Thus, during the network configuration process, the first networking device can test if it can connect to the Internet, or test if there is any other available IP address on the network. In another embodiment, when the network interface of the first networking device is not connected to the network, step 14 can still be executed. After that, when the network interface is connected to the network, the above test is performed to complete the whole network configuration process of the first networking device. Besides, in the embodiment of FIG. 1, if the first networking device has a previous network setting value, step 14 is executed when the previous network setting value is invalid. That is, when the first networking device already has a valid network configuration, there is no need to execute step 14 to configure the first networking device.

Next, it is further explained about how step 14 configures the first networking device according to the network configuration information stored in the storage device. When the network configuration information corresponds to a DHCP (i.e. Dynamic Host Configuration Protocol) configuration, it means the second networking device is a DHCP client, i.e. can obtain the required network setting values from a DHCP server. Thus, step 14 also configures the first networking device as the DHCP client so as to obtain the related network setting values from the DHCP server. In another embodiment, when the network configuration information does not correspond to the DHCP configuration and includes a fixed IP address, a sub-net mask, a gateway address and a DNS server address, step 14 will execute two actions as follows: (1) Since two networking devices cannot use the same IP address, step 14 searches an unused IP address different from the above fixed IP address and then assigns the unused IP address to the first networking device. (2) In the embodiment of FIG. 1, it is assumed that both the first and second networking devices belong to the same network domain. Accordingly, both of them can use the same sub-net mask, gateway and DNS server. Thus, the sub-net mask, the gateway address and the DNS server address included in the network configuration information can be directly set to the first networking device.

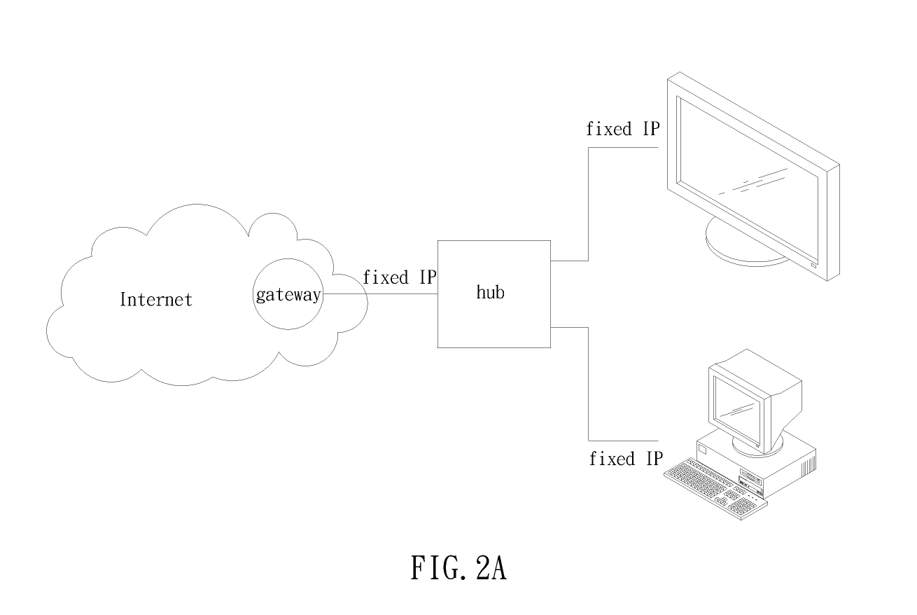

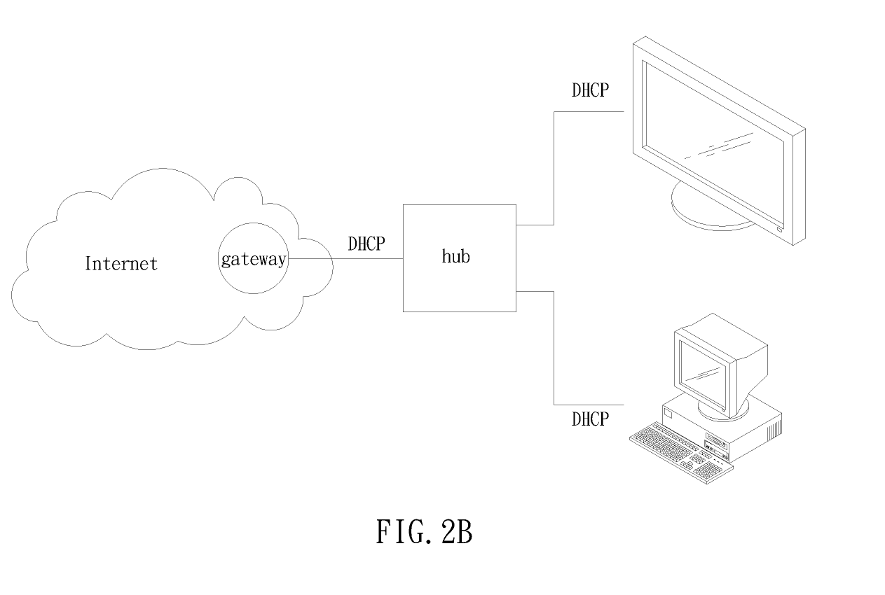

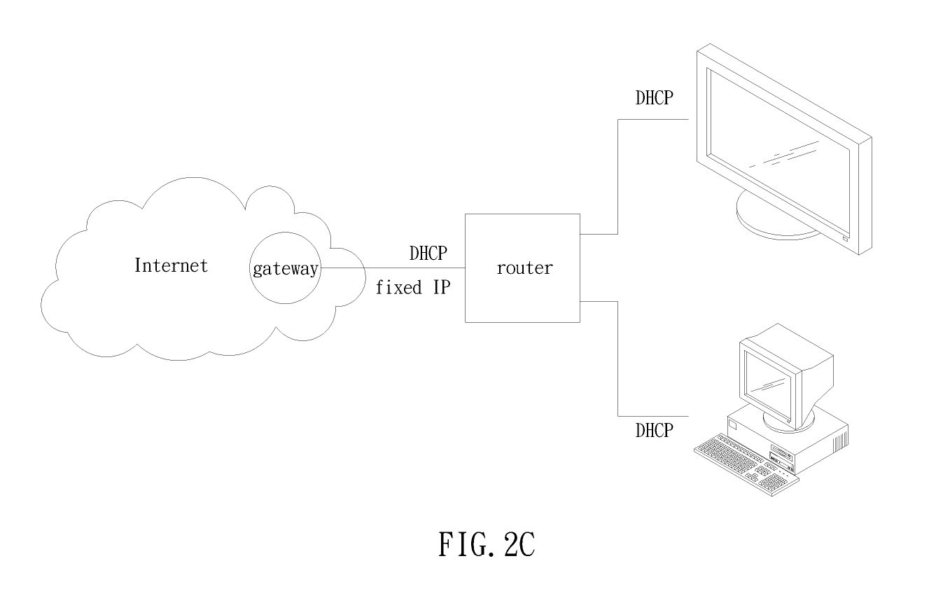

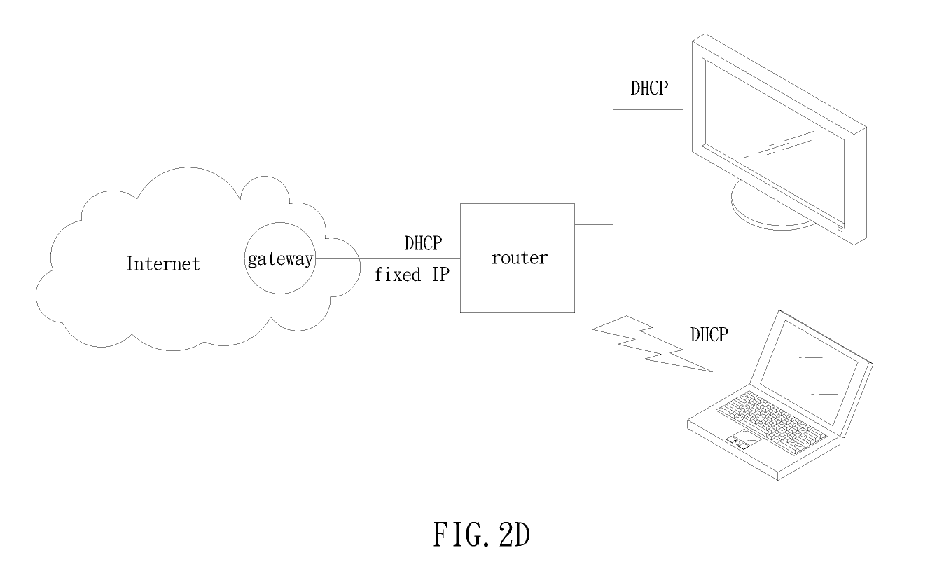

FIGS. 2A-2D show four common network types mostly used in families or small offices. In these network types, the TV and computer are respectively shown as examples of the first and second networking devices, both of which are located in the same LAN. In FIG. 2A, the TV and computer are respectively connected to a hub to form the LAN of the same network domain; the hub is connected to a gateway in the external network so as to connect to the Internet. The computer in FIG. 2A uses a fixed IP address, so when configuring network settings of the TV according to the flow of FIG. 1, step 14 searches an unused IP address different from the IP address of the computer so as to assign it to the TV. Typically the ISP provides a small group of continuous IP addresses to family clients, so when searching the available IP address, step 14 can use the IP address of the computer as a center point and test if the IP addresses before and after the center point are available. For example, if the IP of the computer is 172.21.100.204, then step 14 can test 172.21.100.203,172.21.100.205, 172.21.100.202, 172.21.100.206 . . . in order to see if available. Step 14 can execute test programs, such as a PING program, to determine whether an IP address is available.

Different from FIG. 2A, the computer in FIG. 2B applies the DHCP configuration, and thus step 14 also configures the TV as the DHCP configuration. In this manner, both the computer and TV can obtain required network setting values for connecting to the Internet. In FIG. 2C, the hub is replaced by a router, and both the TV and computer apply the DHCP configuration. The router has the function of network address translation (NAT), so when the router obtains a public IP address (which is used for communicating with the external Internet, and can be a fixed IP or acquired by means of DHCP) from the ISP, the public IP address can be shared by both the computer and TV within the internal LAN to connect to the Internet. More specifically, the router can act as a DHCP server, and provide a private IP address to the computer and TV respectively. When the computer and TV use their respective private IP to connect to the Internet, the router will perform the NAT to translate the private IP into the public IP so as to establish a successful connection with the Internet. The major difference between FIG. 2D and FIG. 2C is that the computer in FIG. 2C is a PC and uses a wired network interface (e.g. Ethernet interface) while the computer in FIG. 2D is a notebook and uses a wireless network interface (e.g. 802.11 series). It is noted that the TV in each network type of FIGS. 2A-2D can also use the wireless network interface, i.e. not limited to the wired network interface.

After the flow of FIG. 1 is completed, a network connection test can be further executed to assure that the first networking device can connect to the Internet. For instance, in FIGS. 2A-2D, the TV can test if the network services which it applies for are present, e.g. the TV can execute the PING program to test if the servers of the network services on the Internet have a response, and the status of each server (e.g. responsive/non-responsive) can be shown on the TV screen for user's reference.

Thus, the embodiment of FIG. 1 is more suitable for being used in a relatively simple network environment: each networking device belongs to the same network domain and the network setting values are not changed frequently, as shown in the network types of FIGS. 2A-2D. For the relatively simple network environment, the embodiment of FIG. 1 can simplify the network configuration process of the networking device (e.g. TV) so as to increase the user's convenience.

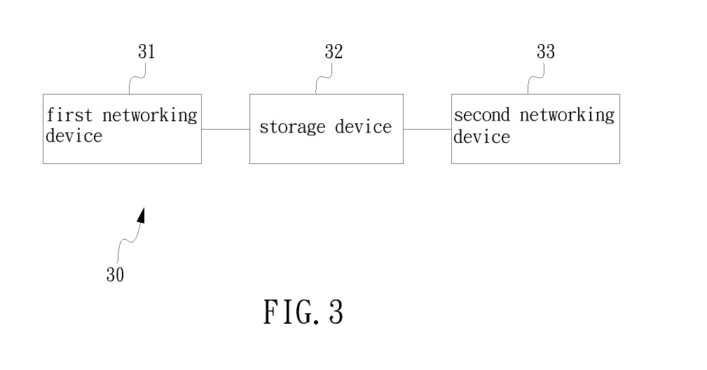

FIG. 3 is a block diagram of an embodiment of the network configuration module, where the network configuration module 30 comprises a first networking device 31, a storage device 32 and a second networking device 33. The first networking device 31 and the second networking device 33 can be a TV and a computer respectively. The storage device 32 can be a USB flash drive. The second networking device 33 has a network configuration information, and the storage device 32 is connected to the second networking device 33 to obtain and store the network configuration information. For example, the second networking device 33 can execute a software program to obtain the network configuration information and store the network configuration information into the storage device 32. Next, the storage device 32 is connected to the first networking device to provide the network configuration information for configuring the first networking device 31.

In the embodiment of FIG. 3, the first networking device 31 is configured when a network interface of the first networking device 31 is connected to a network. Also, if the first networking device 31 has a previous network setting value, the first networking device 31 is configured when the previous network setting value is invalid.

When the first networking device 31 is configured, if the network configuration information stored in the storage device 32 corresponds to a DHCP configuration, then the first networking device 31 is configured as a DHCP client; if the network configuration information does not correspond to the DHCP configuration, then two actions are executed: (1) searching an unused IP address and assigning the unused IP address to the first networking device 31; and (2) directly setting the sub-net mask, the gateway address and the DNS server address included in the network configuration information into the first networking device 31.

Those skilled in the art will readily observe that numerous modifications and alterations of the device and method may be made. Accordingly, the above disclosure should be construed as limited only by the metes and bounds of the appended claims.

What is claimed is:

1. A network configuration method for a networking device comprising steps of:
connecting a storage device to another networking device;
obtaining a network configuration information of the another networking device and storing the network configuration information into the storage device;
connecting the storage device to the networking device; and
configuring the networking device according to the network configuration information stored in the storage device.

2. The network configuration method of claim 1, wherein the networking device is a television.

3. The network configuration method of claim 1, wherein the another networking device is a computer.

4. The network configuration method of claim 1, wherein the storage device is a USB flash drive.

5. The network configuration method of claim 1, wherein in the obtaining step, the network configuration information is obtained by executing a software program by the another networking device.

6. The network configuration method of claim 1, wherein the configuring step is executed when a network interface of the networking device is connected to a network.

7. The network configuration method of claim 6, wherein if the networking device has a previous network setting value, the configuring step is executed when the previous network setting value is invalid.

8. The network configuration method of claim 1, wherein when the network configuration information corresponds to a DHCP configuration, the configuring step configures the networking device as a DHCP client.

9. The network configuration method of claim 8, wherein when the network configuration information does not correspond to the DHCP configuration, the configuring step comprises searching an unused IP address and assigning the unused IP address to the networking device.

10. A network configuration module comprising:
a first networking device;
a second networking device having a network configuration information; and
a storage device for obtaining and storing the network configuration information from the second networking device;
wherein the storage device provides the first networking device the network configuration information for configuring the first networking device.

11. The network configuration module of claim 10, wherein the first networking device is a television.

12. The network configuration module of claim 10, wherein the second networking device is a computer.

13. The network configuration module of claim 10, wherein the storage device is a USB flash drive.

14. The network configuration module of claim 10, wherein the second networking device executes a software program to obtain the network configuration information and store the network configuration information into the storage device.

15. The network configuration module of claim 10, wherein the first networking device is configured when a network interface of the first networking device is connected to a network.

16. The network configuration module of claim 15, wherein if the first networking device has a previous network setting value, the first networking device is configured when the previous network setting value is invalid.

17. The network configuration module of claim 10, wherein when the network configuration information corresponds to a DHCP configuration, the first networking device is configured as a DHCP client.

18. The network configuration module of claim 17, wherein when the network configuration information does not correspond to the DHCP configuration, the first networking device searches an unused IP address and assigns the unused IP address to itself.
